(19) United States
(12) Patent Application Publication
(10) Pub. No.: US 2011/0109125 A1
(43) Pub. Date: May 12, 2011

(54) CARRIAGE FOR A VEHICLE WINDOW LIFTER, AND VEHICLE STRUCTURE HAVING A WINDOW LIFTER

(76) Inventors: Karl-Heinz Kreher, Muhlheim (DE); Norbert Kleen, Wendeburg (DE)

(21) Appl. No.: 12/939,470

(22) Filed: Nov. 4, 2010

(30) Foreign Application Priority Data
Nov. 10, 2009 (DE) 10 2009 052 569.6

(51) Int. Cl. B60J 1/17; E05D 15/22; B60J 1/14

(52) U.S. Cl. 296/201; 49/176; 49/506

(57) ABSTRACT

A carriage for a vehicle window lifter has a frame with a guide for receiving a guide rail, a carrier plate which is mounted on the frame to be pivotable about a pivot axis perpendicular to the direction of the guide, and an adjusting mechanism that allows the carrier plate to be aligned relative to the frame about the pivot axis. The adjusting mechanism has a tool receptacle which is aligned substantially in the direction of the guide.

### RELATED APPLICATION

This application claims priority to German Application No. 10 2009 052 569.6, which was filed Nov. 10, 2009.

### FIELD OF THE INVENTION

The invention relates to a carriage for a vehicle window lifter having a frame, which has a guide for receiving a guide rail, and having a carrier plate for fastening a window pane. The invention also relates to a vehicle structure having a window lifter system and to a method for horizontal alignment of a window pane in such a vehicle structure.

### BACKGROUND

Presently, conventional window lifter systems for vehicles with frameless doors usually have at least one carriage on which a window pane is held. The carriage is mounted in a movable manner on a rail or in a guide track and can be moved along the latter in order to move the window pane between an open position and a closed position. After the mounting of the window pane in the vehicle, the window pane must be aligned in order to ensure that, when the window pane is moved into the closed position, the window pane can run precisely into a seal provided on the door or on the vehicle, and can bear against the seal in the closed position.

Also, a carriage for a vehicle window lifter, a vehicle structure having a window lifter, and a method for adjusting a window pane should provide simple and fast alignment of the window pane.

### SUMMARY

A carriage for a vehicle window lifter includes a frame with a guide for receiving a guide rail, and includes a carrier plate which is mounted on the frame to be pivotable about a pivot axis perpendicular to a direction of the guide. The pivot axis is preferably parallel or approximately parallel to the vehicle longitudinal axis. Provided on the carriage is an adjusting mechanism that allows the carrier plate to be aligned relative to the frame about the pivot axis. After the mounting of the window pane, the latter is directly or indirectly fixedly connected to the carrier plate. The adjusting mechanism has a tool receptacle which is aligned substantially in the direction of the guide. This makes it possible to adjust the carriage of the window lifter system, which has been mounted in a vehicle structure, for example a vehicle door, without the need to dismount parts of the vehicle structure, such as inner paneling for example. This is achieved in that an adjusting mechanism is provided which can be accessed and adjusted from above, that is to say through an exit slot of the window pane. In particular, a tool receptacle of the carriage is aligned in the direction of the guide with which the carriage is mounted on a guide rail of the window lifter system. The tool receptacle can thus be easily accessed using a tool which is introduced into the vehicle structure in the direction of the guide rail. The tool may for example be inserted through the exit slot through which the window pane emerges out of the vehicle structure, such that no dismounting of parts of the vehicle paneling is necessary. If the window pane is moved into a nearly-closed position, the tool receptacle can be accessed particularly easily because, in this position, the carriage is situated close to the exit slot of the vehicle structure. Furthermore, a simple comparison of the intended position and actual position of the window pane is possible in this position. Furthermore, in the case of a frameless window, an alignment is possible when the vehicle door is closed.

The adjusting mechanism preferably has an adjusting screw which permits a continuously variable adjustment of the adjusting mechanism, and therefore a continuously variable alignment of the vehicle window pane.

A slide may be mounted on the adjusting screw, which slide is moved along the screw when the screw is rotated. For this purpose, the slide is guided in a rail on the adjusting mechanism, such that the slide cannot co-rotate with the adjusting screw when the latter is rotated. The rotational movement of the adjusting screw can be converted in a simple manner into a pivoting movement of the carrier plate by way of the linear movement of the slide.

For the pivoting of the carrier plate, a slotted guide may be provided which is formed by a guide slot and a sliding block. Here, it is, for example, possible for the sliding block to be arranged on the slide and for the guide slot to be arranged on the carrier plate. A slot path runs at an angle with respect to an axis of the screw, such that a relative movement is caused by a vertical movement of the sliding block. The interface between the sliding block and slotted guide may, for example, be formed by a cylindrical body which engages into a slot, or by a slot in the sliding block which slides on a rib. The sliding block projects into the guide slot and is moved along the guide slot during a movement of the slide as a result of the rotation of the adjusting screw. By way of a corresponding design of the guide slot, the guide slot and the carrier plate fastened thereto are moved horizontally.

The guide slot may, for example, be adapted in any desired manner depending on the desired adjustment range of the carriage. It is, for example, conceivable for the guide slot to be rectilinear at least in sections.

It is also possible for the guide slot to be curved at least in sections, as a result of which the ratio of adjusting screw rotation to pivot angle of the window pane can be adjusted.

To reduce the structural depth of the carriage in a vehicle door, the adjusting screw is arranged substantially perpendicular to the pivot axis of the carrier plate. The adjusting screw is thus situated in a plane of the frame, such that a very flat design of the carriage is possible.

The carrier plate may also be mounted on the pivot axis to be movable to a limited extent in the direction of the pivot axis, as a result of which tolerance compensation in the direction of the pivot axis is possible.

To center the carrier plate on the frame, the carriage has, for example, at least one spring element which engages on the carrier plate and acts on the latter with a restoring force aligned in the direction of the pivot axis. It is also conceivable for two oppositely arranged spring elements to be provided, which center the carrier plate in a middle position.

Also provided is a vehicle structure having a window lifter system. The window lifter system has at least one guide rail and also has at least one carriage which is mounted on the guide rail to be movable in the direction of the guide rail and on which is held a window pane. The window pane can be pushed along the guide rail and into a closed position through an exit slot in the door. The carriage is a carriage as described above, and the tool receptacle of the carriage is provided on that side of the carriage which faces toward the exit slot. A tool may thus be introduced into the vehicle door through the exit slot, such that an alignment of the window pane is possible regardless of the position of the window pane. The window pane may thus, for example, be aligned in an almost completely closed position. This firstly offers the advantage that the tool receptacle is more easily accessible in this position, and secondly, in this position, a simple comparison of the intended position and actual position of the window pane is possible. Furthermore, in the case of a frameless window, an alignment is possible when the vehicle door is closed.

Also provided is a method for the horizontal alignment of a window pane in a vehicle door including inserting the window pane into the at least one carrier plate of the window lifter system, introducing a tool through the exit slot into the tool receptacle of the carriage, and horizontally pivoting the window pane by actuating the adjusting mechanism using the tool, with the window pane being situated in an at least approximately closed position.

In an approximately closed position of the window pane, the latter is situated close to the seal, such that fast and simple alignment can take place. Furthermore, in this position of the window pane, the tool receptacle is more easily accessible through the exit slot because the carriage is situated higher up and therefore closer to the exit slot. Dismounting of the door inner paneling, for example, is not required in order to access the adjusting mechanism, such that the alignment of the window pane can take place significantly more quickly.

### BRIEF DESCRIPTION OF THE DRAWINGS

Further advantages and features of the present invention will emerge from the following description in connection with the appended drawings, in which:

FIG. 1 shows a general view of a vehicle structure,

FIG. 2 shows a detail view of the vehicle structure from FIG. 1 with a carriage according to the invention,

FIG. 3 shows a sectional view through the carriage from FIG. 2 along the section line III-III,

FIG. 4 shows a second sectional view through the carriage from FIG. 2 along the section line IV-IV,

FIG. 5 shows a view of a second embodiment of a window lifter system according to the invention,

FIG. 6 shows a detail view of the carriage of the vehicle structure from FIG. 5, and

FIG. 7 shows a detail view of the adjusting mechanism of the vehicle structure from FIG. 5.

### DETAILED DESCRIPTION

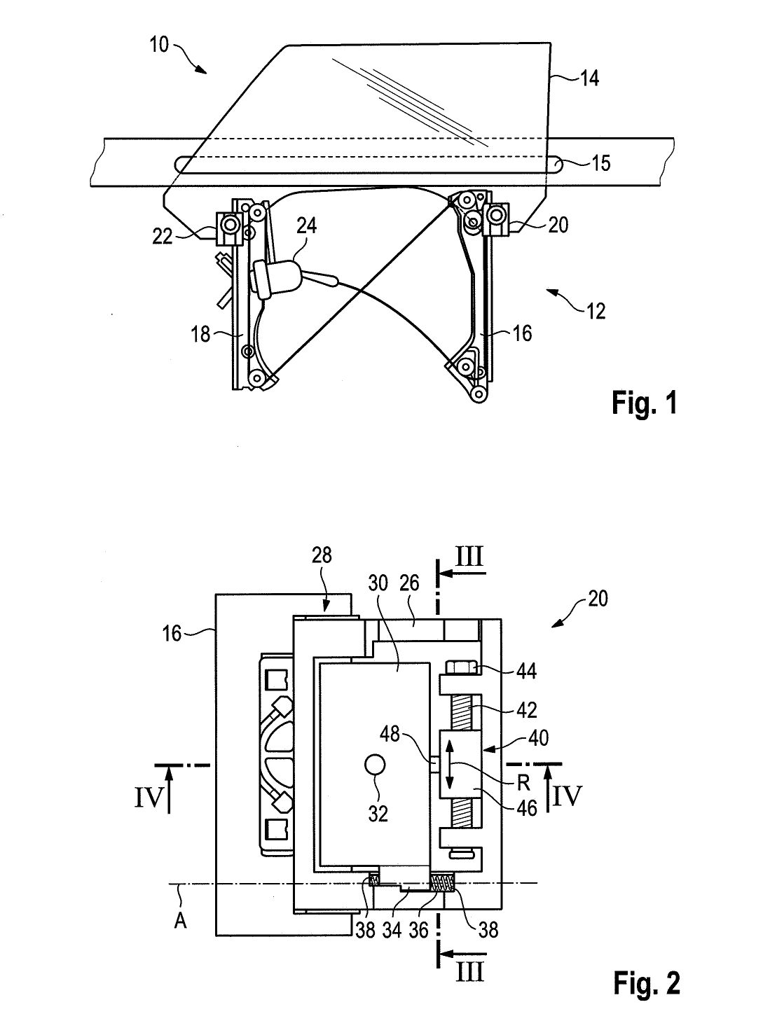

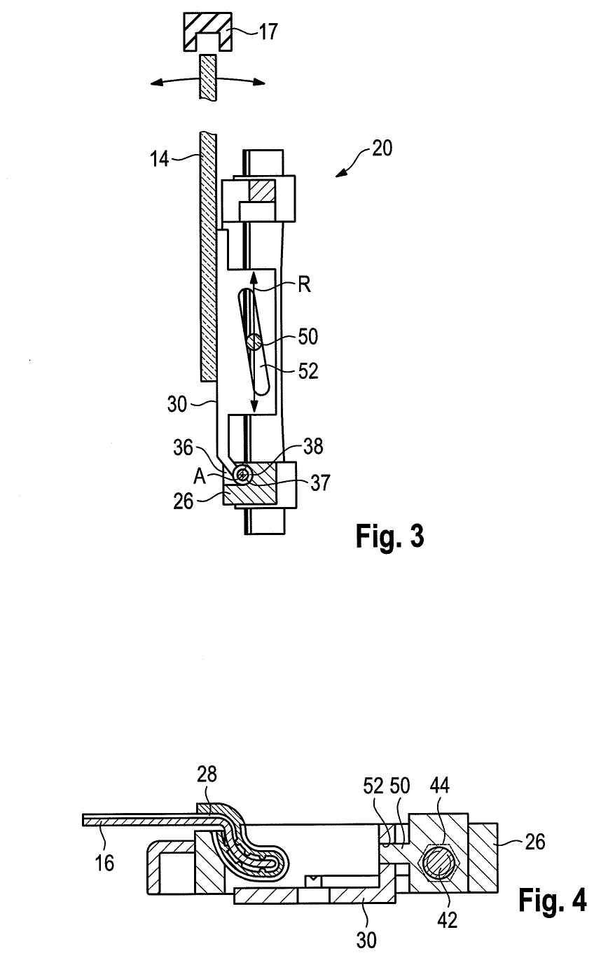

FIG. 1 illustrates a vehicle structure 10, in this case a vehicle door, having a window lifter system 12 which can move a window pane 14 substantially vertically between an open position and a closed position. In the open position, the window pane 14 is situated substantially in the interior of the vehicle structure 10. To pass into the closed position, the window pane 14 is moved upward through an exit slot 15, which in this case runs horizontally, in the vehicle structure 10 to close off an opening of the vehicle. In the closed position, the window pane 14 bears at least with the top edge against a seal 17, or projects into the seal (see FIG. 3).

The window lifter system 12 has a first guide rail 16 and a second guide rail 18, which in this case are arranged substantially approximately vertically and parallel to one another. Mounted on each of the guide rails 16, 18 to be movable vertically is a carriage 20, 22 on which the window pane 14 is held. Furthermore, the window lifter system 12 has a drive 24 which can move the carriages 20, 22 along the guide rails 16, 18.

The carriage 20 shown in FIG. 2 has a frame 26 which is rectangular in shape and which, at its left-hand edge in FIG. 2, has a guide 28 by which the carriage 20 is movably mounted on the first guide rail 16 (see also FIG. 4).

Furthermore, the carriage 20 has a carrier plate 30 which has a fastening opening 32 to which the window pane 14 can be fastened using a suitable fastener. The carrier plate 30 is mounted, by projection 34 provided on the lower edge of the carrier plate 30, on a bolt 37 which is provided in a cutout 36 at the lower edge of the frame 26, such that the carrier plate 30 is pivotable about a pivot axis A arranged perpendicular to the guide 28 (see FIG. 3).

Furthermore, the carrier plate 30 is mounted in the cutout 36 to be movable to a limited extent in the direction of the pivot axis A. To hold the carrier plate 30 in a middle position on the frame 26, two spring elements 38, in this case spiral springs, are provided which act on the carrier plate 30 with a restoring force aligned in the direction of the pivot axis.

The carriage 20 has an adjusting mechanism 40 with which the carrier plate 30 can be aligned relative to the frame 26 about the pivot axis A. The adjusting mechanism 40 has an adjusting screw 42, which in this case is arranged substantially in the direction of the guide 28. The adjusting screw 42 is rotatably mounted on the frame 26 and has a tool receptacle 44 which is formed in this case by the screw head and which is aligned substantially in the direction of the guide 28 such that a tool can engage into the tool receptacle 44 vertically from above in FIGS. 1 and 2. The tool receptacle 44 has a conventional form for receiving a screw wrench, a screwdriver, a Torx wrench or a hexagon socket. Other forms of tool receptacle 44 are, however, also conceivable. Since the tool must be inserted into the tool receptacle “blind”, it is conceivable as an auxiliary device to provide a conical or funnel-shaped widening of the carrier plate 30 or more preferably of the frame 26, which widening guides the tool, as it is inserted, to the tool receptacle 44.

Furthermore, the adjusting mechanism 40 has a slide 46 and also a slotted guide 48. The slide 46 is mounted on the frame 26 to be movable in an actuating direction R and has an internal thread into which the external thread of the adjusting screw 42 engages. When the adjusting screw 42 is rotated, the slide 46 is moved along the adjusting screw 42 in the actuating direction R.

The slotted guide 48 has a guide slot 52 which is provided on the carrier plate 30 and into which projects a sliding block 50 which is provided on the slide 46. As can be seen in the sectional view in FIG. 3, the guide slot 52 is rectilinear and is inclined relative to the actuating direction of the slide 46.

It is, however, also conceivable for the guide slot to be curved at least in sections, as a result of which the ratio of adjusting screw rotation to pivot angle of the carrier plate can be adjusted.

If the slide 46 is moved with the sliding block 50 in the actuating direction R, the guide slot 52 is moved transversely with respect to the actuating direction R, and therefore the carrier plate 30 and a window pane 14, which is held on the carrier plate 30, are pivoted about the pivot axis A. The carrier plate 30 and the window pane 14, which is held on the carrier plate 30, are pivoted horizontally about the pivot axis A. The window pane 14 can in this way be aligned horizontally with a seal 17 provided on the vehicle structure 10 (see arrows in FIG. 3).

Here, the tool receptacle 44 is designed such that a tool can engage into the receptacle in the direction of the guide 28, in this case vertically from above. The tool can for example be introduced through the exit slot 15 of the window pane 14 out of the vehicle structure 10.

To align the window pane 14 with the seal 17, the window pane 14 can, after being mounted on the window lifter system 12, be moved into an approximately closed position in which the window pane 14 nearly bears against the seal 17 or is almost inserted into the seal. In this position, fast and precise alignment of the window pane 14 is possible because a quick visual comparison of the intended position and actual position is possible. Furthermore, in this position of the window pane 14, the tool receptacle 44 is easily accessible because the tool receptacle 44 is situated higher up and therefore closer to the exit slot 15. A tool is subsequently inserted into the tool receptacle 44 through the exit slot 15, and the window pane is aligned with respect to the seal 17 by adjusting the carriage 20. Dismounting of parts of the inner paneling, for example, is not required, such that the alignment of the window pane 14 can take place significantly more quickly.

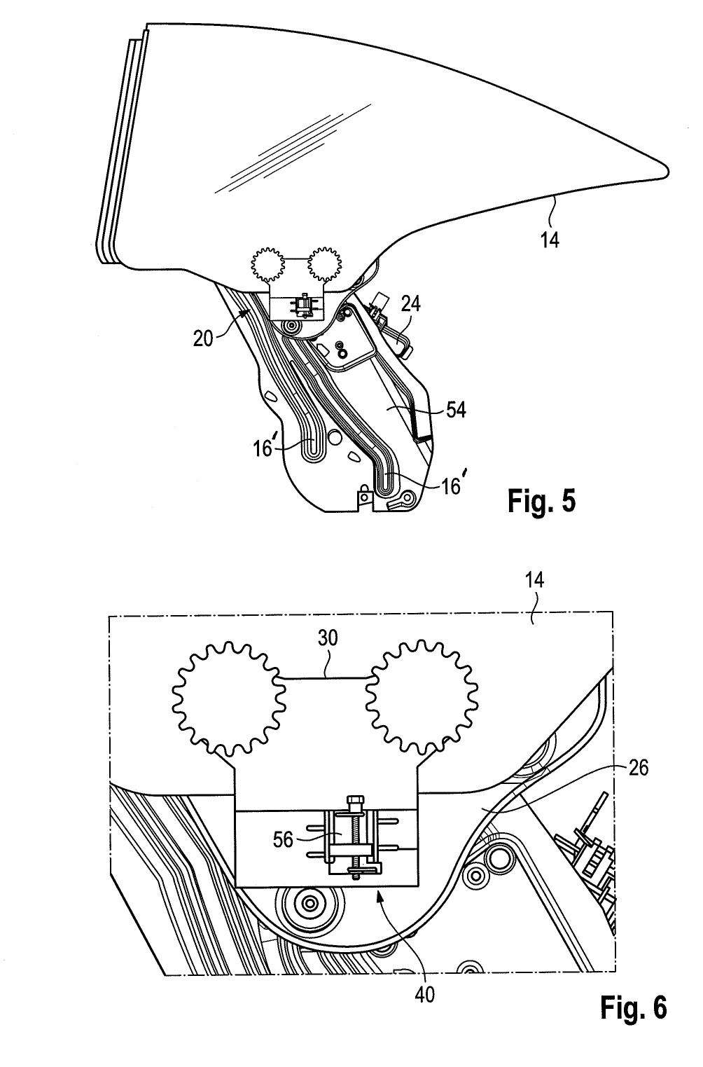

A second embodiment of a vehicle structure according to the invention is shown in FIG. 5. Here, the window pane 14 is mounted on a carrier plate 54 with guide tracks 16′. Here, the guide tracks 16′ are curved. By way of the design of the guide tracks 16′, it is possible for the window pane 14, as it is moved from one position into the other position, to not only be moved horizontally but rather also to be pivoted, or moved vertically, in order to be able to slide the window pane 14 as far as possible into the vehicle structure even if spatial conditions in the vehicle structure 10 are restricted.

The window lifter system 12 has a single carriage 20 which has a substantially plate-shaped frame 26 (FIG. 6). In the same way as in the first embodiment, the carrier plate 30 is pivotably mounted on the frame 26. Here, the carrier plate has an opening 56 through which the adjusting mechanism 40 which is arranged on the frame projects.

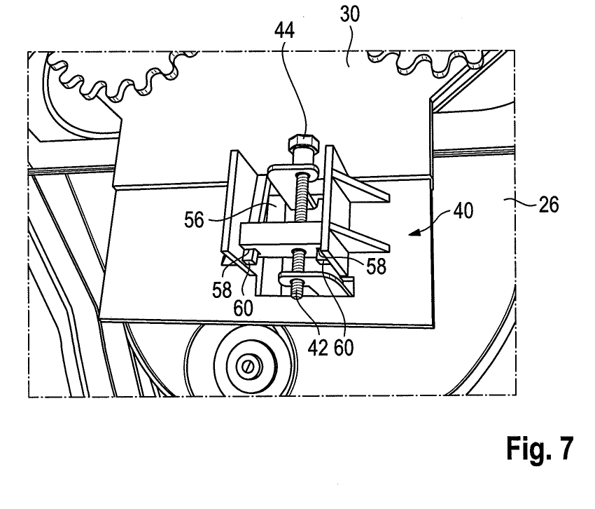

Here, the adjusting mechanism 40 likewise has an adjusting screw 42 having a tool receptacle 44 which is aligned in the direction of the guide 28 and also has a slide 46 which is mounted on the adjusting screw 42. Here, a slotted guide is formed by two cutouts 58 provided on the slide 46 and by two rails 60 provided on the carrier element (see FIG. 7), which are inclined with respect to the direction of the adjusting screw 42.

When the adjusting screw 42 is rotated, the slide 46 is moved along the rails 60, such that the carrier plate 30 is pivoted horizontally.

As can be seen in FIG. 5, the guide track 16 is designed such that, in the approximately closed position of the window, the carriage is aligned substantially horizontally, such that in this position, the tool receptacle is aligned vertically upward. In this position of the carriage 20, the tool receptacle 44 can be operated by a tool introduced vertically from above, which tool may for example be introduced through the exit slot 15 of the window pane 14.

Instead of the adjusting mechanism 40 with a slotted guide 48 used here, other adjusting mechanisms 40 are also conceivable. In particular, it is not necessary for the adjusting mechanism 40 to have an adjusting screw 42 or a slide 46. The carrier plate 30 may also be pivoted about the pivot axis in any other way.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A carriage for a vehicle window lifter comprising:
a frame with a guide for receiving a guide rail;
a carrier plate mounted on the frame to be pivotable about a pivot axis perpendicular to a direction of the guide; and
an adjusting mechanism to align the carrier plate relative to the frame about the pivot axis, with the adjusting mechanism having a tool receptacle which is aligned substantially in the direction of the guide.

2. The carriage as set forth in claim 1, wherein the adjusting mechanism has an adjusting screw.

3. The carriage as set forth in claim 2, wherein a slide is mounted on the adjusting screw, which slide is moved along the adjusting screw when the adjusting screw is rotated.

4. The carriage as set forth in claim 3, including a slotted guide formed by a guide slot and a sliding block, with a slot path running at an angle to a screw axis to cause, in the event of a movement relative to a vertical direction, a movement of the sliding block.

5. The carriage as set forth in claim 4, wherein the guide slot is rectilinear at least in sections.

6. The carriage as set forth in claim 4, wherein the guide slot is curved at least in sections.

7. The carriage as set forth in claim 2, wherein the adjusting screw is arranged substantially perpendicular to the pivot axis of the carrier plate.

8. The carriage as set forth in claim 1, wherein the carrier plate is mounted on the pivot axis to be movable to a limited extent in a direction of the pivot axis.

9. The carriage as set forth in claim 8, wherein the carriage has at least one spring element which engages on the carrier plate and acts on the carrier plate with a restoring force aligned in a direction of the pivot axis.

10. A vehicle structure having a window lifter system including:
at least one guide rail;
at least one carriage which is mounted on the at least one guide rail to be movable in a direction of the at least one guide rail and on which is held a window pane that is movable along the at least one guide rail and out of a door through an exit slot in the door, and wherein the at least one carriage comprises a frame with a guide for receiving a guide rail, a carrier plate mounted on the frame to be pivotable about a pivot axis perpendicular to a direction of the guide, and an adjusting mechanism to align the carrier plate relative to the frame about the pivot axis, with the adjusting mechanism having a tool receptacle which is aligned substantially in the direction of the guide and with the tool receptacle of the carriage being provided on that side of the carriage which faces toward the exit slot.

11. A method for horizontal alignment of a window pane in a vehicle structure including the steps of:
inserting the window pane into at least one carrier plate of a window lifter system,
introducing a tool through an exit slot in a door and into a tool receptacle of a carriage, and
horizontally pivoting the window pane by actuating an adjusting mechanism using the tool, with the window pane being situated in an at least approximately closed position.
